(19) United States
(12) Patent Application Publication
(10) Pub. No.: US 2017/0228129 A1
(43) Pub. Date: Aug. 10, 2017

(54) DUAL ENVIRONMENTS WITH THREE-DIMENSIONAL EARTH-LIKE GRAPHICAL USER INTERFACE FOR A COMPUTING DEVICE

(71) Applicants: Winifred Shen, Elmhurst, NY (US); Joe Shen, Elmhurst, NY (US)

(72) Inventors: Winifred Shen, Elmhurst, NY (US); Joe Shen, Elmhurst, NY (US)

(21) Appl. No.: 15/018,498

(22) Filed: Feb. 8, 2016

(51) Int. Cl. G06F 3/0481; H04W 4/00; G06T 19/00

(52) U.S. Cl. CPC G06F 3/04815; G06T 19/003; G06F 3/04817; H04W 4/008; G06T 2200/24

(57) ABSTRACT

Implementations disclose dual environments with a 3-D Earth-like graphical user interface within one computing device. A method of one implementation includes causing a display device to render a graphical user interface (GUI) that is three-dimensional and spherical, the GUI comprising dual environments comprising a northern hemisphere and a southern hemisphere, wherein applications correspond to at least one of the northern hemisphere, the southern hemisphere, or an equator between the northern and southern hemispheres, responsive to a trigger indication, submissively causing applications of a first environment of the dual environments to be inactive in order to hibernate the first environment on the computing device, and causing the display device to render the GUI to present, in a majority of the GUI, applications corresponding to the equator and to a second environment of the dual environments on a display of the computing device.

### TECHNICAL FIELD

Implementations of the disclosure relate to computing devices, and in particular, to dual environments with three-dimensional earth-like graphical user interface for a computing device.

### BACKGROUND

With the popular demand and rapidly growing success of telecommunications, mobile devices have gone from a luxury to a necessity. People are often multi-tasking heavily on mobile devices for business, work, or personal chores around the clock. However, under different communication requirements, networks may demand specific security credentials embedded in their mobile devices. People looking for quick and easy access may neglect network security breaches.

### BRIEF DESCRIPTION OF THE DRAWINGS

The accompanying drawings, which are incorporated herein and form a part of the specification, illustrate the present disclosure and, together with the description, further serve to explain the principles of the disclosure and to enable a person skilled in the pertinent art to make and use the disclosure. The present disclosure is illustrated by way of examples, and not by way of limitation, in the figures of the accompanying drawings.

FIG. 1 illustrates 3-D Earth-like graphical user interface systems and methods to show both active environments.

FIG. 2 illustrates 3-D Earth-like graphical user interface systems and methods to show one revived environment in the northern hemisphere while the other environment in the southern hemisphere is hibernated.

FIG. 3 illustrates a figure of three raised icons representing applications being executed, minimized, and running in the background in accordance with one implementation of the disclosure.

FIG. 4 is a block diagram illustrating an exemplary system architecture, in accordance with one implementation of the disclosure.

FIG. 5 is a flow chart illustrating 3-D Earth-like graphical user interface systems and methods to show smart phones are submissively revived or hibernated between home and business environments triggered by RF signals of an NFC device according to an implementation of the disclosure.

FIG. 6 is a flow chart illustrating 3-D Earth-like graphical user interface systems and methods to show smart phones are submissively in vibrate or ring mode triggered by RF signals of an NFC device according to an implementation of the disclosure.

FIG. 7 is a flow diagram illustrating a method for providing dual environment with 3-D Earth-like GUI according to an implementation of the disclosure.

FIG. 8 is a block diagram illustrating an exemplary computer system, according to some implementations.

### DETAILED DESCRIPTION

Implementations of the disclosure provide systems and methods for dual environments with a three-dimensional (3-D) Earth-like graphical user interface (GUI) for easy user access to the dual environments within one computing device. The computing device is authenticated under the same or different network security systems to access the same or different communication networks. Furthermore, both environments could use the same operating systems or different ones.

All applications are active or inactive based on their environments, which can be submissively switched between revived and hibernated modes based on, but not limited to, time, location, network (e.g., mobile telecommunication network, local area network, wide area network), wireless communication network (e.g., Wi-Fi, radio frequencies), programmed schedule, and/or biometric security. As used herein, the term “submissive” and/or “submissively” may refer to performing an action without end user input, control, and/or interaction.

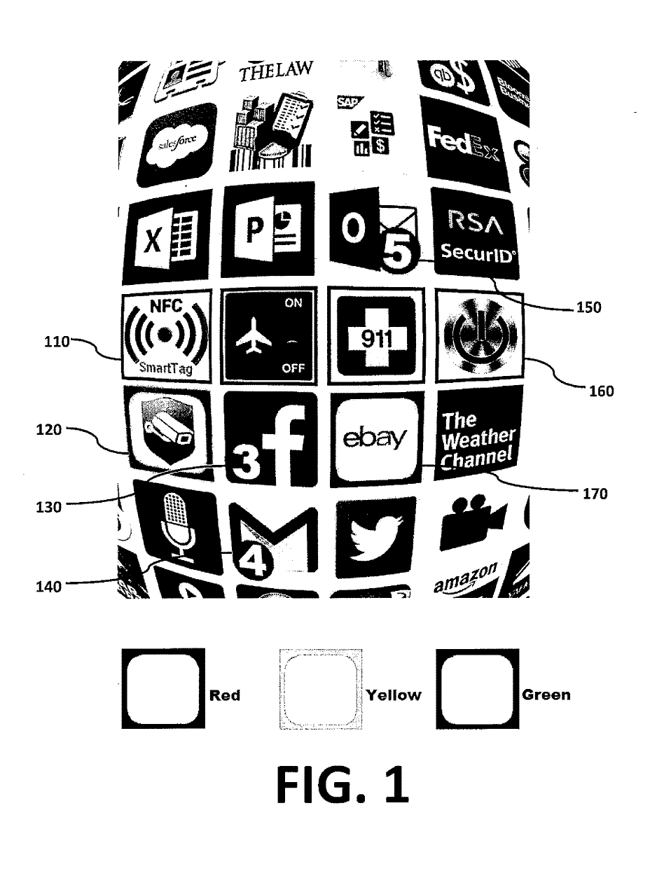

In one implementation, the methods and systems for dual environments with the 3-D Earth-like GUI are implemented using icons as shown FIG. 1. In implementations of the disclosure, “Earth-like” refers to an appearance that is round and/or spherical in shape. FIG. 1 illustrates an exemplary GUI 100 including a plurality of icons. Each icon represents an application.

Icons on the equator are applications (e.g., icon 110, in FIG. 1, is a near field communication (NFC) SmartTag application) not belonging to either environment. According to one implementation, applications disposed along the equator of the GUI 100 may have black outlines and are always active. Active may refer to the application as running and accessible at all times.

In one implementation, all icons of the GUI 100 can be framed in different colors each of which represent a different status. Examples of status include, but are not limited to, active (e.g., when application is on-line), inactive (e.g., when application is off-line and is warning user that its environment is hibernated), and alert (e.g., when application is alarming user).

FIG. 1 illustrates 3-D Earth-like graphical user interface systems and methods to show both active environments according to an implementation of the disclosure.

Icons can be framed in different colors that represent a different status comprising at least one of active, inactive, or alert. Raised icons are being executed and the minimized, running applications in the background. Icons on the equator are applications that do not belong to either environment. They have black outlines and are always active and can be executed at any time.

Icon 110 is an NFC SmartTag application on the equator.

Icon 120 is a Surveillance Security Camera application framed in green which shows active on-line status.

Icon 130 is a Social Media application (Facebook) with 3 new message notifications.

Icon 140 is an e-Mail application (Gmail) with 4 new mail notifications.

Icon 150 is an e-Mail application (Outlook) with 5 new mail notifications.

Icon 160 is the power button on the equator.

Icon 170 is an online auction application (eBay) framed in red which alerts users their bidding time is ending soon.

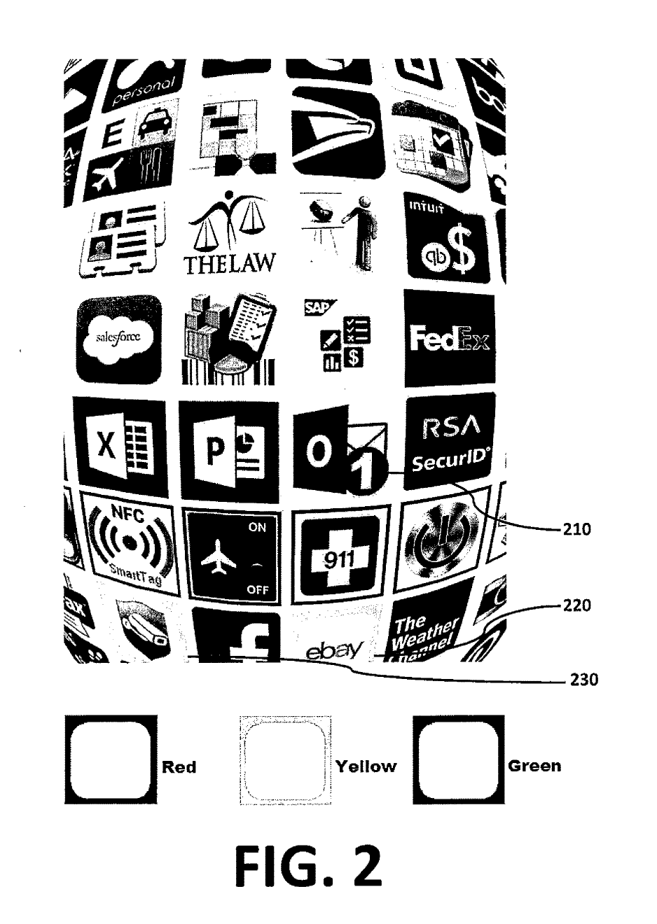

FIG. 2 illustrates 3-D Earth-like graphical user interface systems and methods to show the northern hemisphere environment is revived while the southern hemisphere environment is hibernated according to an implementation of the disclosure.

Icon 210 is an e-Mail application (Outlook) with 1 new mail notification.

Icon 220 is an online auction application (eBay) is framed in yellow, indicating an inactive off-line status because its environment is hibernated.

Icon 230 is a Surveillance Security Camera application is framed in yellow, indicating an inactive off-line status because its environment is hibernated.

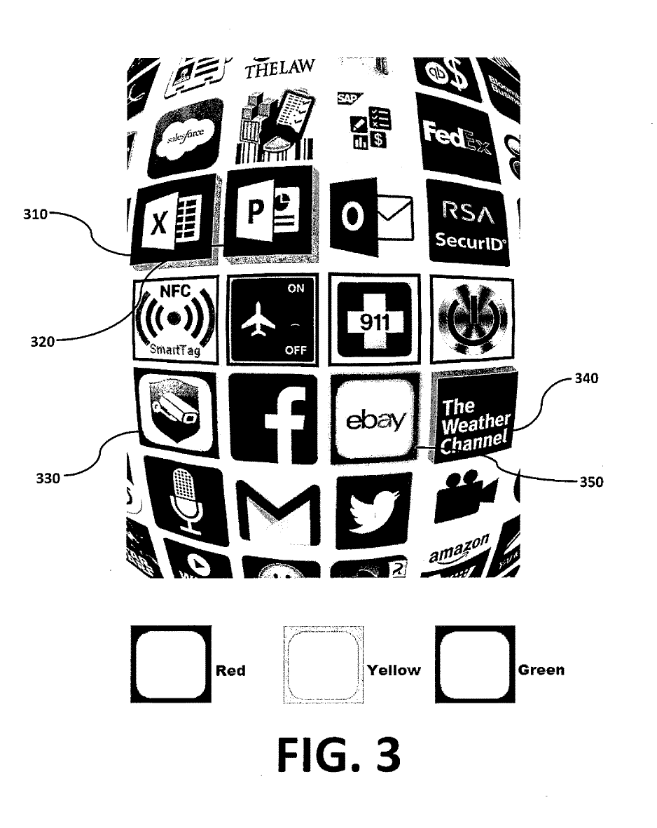

FIG. 3 illustrates 3-D Earth-like graphical user interface systems and methods showing icon 310, icon 320, and icon 340 as raised icons represent applications being executed, minimized, and, running in the background).

Icon 330 is a Surveillance Security Camera application framed in red which alerts users with break-in alarm.

Icon 350 is an online auction application (eBay) framed in green which shows active on-line status.

In an implementation of the disclosure, the graphical user interface methods and systems of the disclosure described herein are implemented using well-known computer icons as shown in FIGS. 1 through 3. The disclosure can work with software, hardware, and operating system implementations other than those described herein. Any software, hardware, and operating system implementation suitable for performing the functions described herein can be used.

In one implementation, as shown in the GUIs of FIGS. 1 through 3, the methods and systems for dual environments with 3-D Earth-like graphical user interface apply to two environments: a “northern hemisphere” for business use and a “southern hemisphere” for home and/or personal use. In one example, when an end user, such as an employee, goes to his or her office and passes through a security gate, the employee may tag (e.g., place near or in proximity to) his or her mobile device as a key-card against NFC sensors. A security system may then authenticate the employee's credentials (stored in the employee's mobile device), upload a clock-in time-stamp to an attendance server, and open the security gate. The example of an NFC device and interactions with such NFC devices are described herein for ease of understanding. Implementations of the disclosure are not limited to solely interactions with NFC devices, and also include interactions with other types of networks and/or modes of triggering the submissive change between dual environments discussed herein.

In implementations of the disclosure, employees' mobile devices are submissively triggered by NFC radio frequencies at the NFC sensors to hibernate the home environment (e.g., the southern hemisphere) and revive the business environment (e.g., the northern hemisphere) on the mobile device. In one implementation, when an environment (e.g., northern or southern hemisphere) is in a hibernated mode, all applications in that hemisphere are inactive. An application may include any computer program designed to perform a group of coordinated functions, tasks, or activities for the benefit of the end user. Examples of an application include a word processor, a spreadsheet, an accounting application, a web browser, a Media player, a social media application, an aeronautical flight simulator, a console game, or a photo editor. The collective noun “application software” refers to all applications collectively. Applications may be bundled with the computer and its system software or published separately, and may be coded as proprietary, open-source, or university projects. When an application is “inactive” in the hibernated mode, that may refer to disabling the application so that the end user cannot interact with the application (e.g., inoperable).

In some implementations, when the end user enters into restricted areas, NFC radio frequencies may trigger the end user's mobile device to be in an “airplane mode” as well as disable the camera, the camcorder and the recorder functionalities of the mobile device. When the end user leaves the restricted area, security systems may then authenticate the end user's credentials and upload the clock-out time-stamp to an attendance server. In addition, the NFC radio frequencies trigger the end user mobile device not only to revive the home environment (e.g., the southern hemisphere) and hibernate the business environment (e.g., the northern hemisphere), but also submissively report any non-business activities to the security system the end user had manually revived the home environment to execute any application while the mobile device was operating in the business environment.

In one example, implementations of the disclosure may be utilized at movie theaters. For example, moviegoers can purchase movie tickets on-line and store e-tickets in their mobile phones' NFC application. When checking into the movie theater, the moviegoer may tag their mobile phones as key-cards against NFC sensors at the theater. Security systems can then validate the e-tickets and allow the moviegoer to enter the theater. In addition, in one example implementation, the moviegoers' mobile phones are submissively triggered by the NFC radio frequencies to enter into a vibrating and/or silent mode and also disable the camcorder function.

In another implementation, the methods and systems for dual environments with the 3-D Earth-like graphical user interface described herein may be utilized with applications that can be submissively controlled by traffic control centers' networks (e.g., telecommunication networks or radio frequencies), which can be installed in traffic lights or speed limit signs.

In a further implementation, a Samsung® Galaxy® S6 Duos® G9200 Global Systems for Mobile Communications (GSM) phone can be used in both AT&T® and T-Mobile® telecommunication networks. In one implementation, the dual environments described herein may include the two environments of the AT&T® Android® operating system (OS) and the T-Mobile® Windows® Mobile OS. Both environments use the GSM telecommunication standards, but one environment is implemented using the Android® OS and other environment is implemented using the Window® Mobile OS. Users may choose which environment is revived or hibernated accordingly.

In a further implementation, Apple® iPhone® 6, model number A1549, is compatible with both GSM and code division multiple access (CDMA) carriers. In one implementation, the dual environments of the 3-D Earth-like graphical user interface described herein may include the two environments of the AT&T®'s GSM and the Verizon®'s CDMA. The OSs of both environments are Apple® iOS®, but one environment is using the GSM telecommunication standards and the other environment is using the CDMA telecommunication standards. User may choose which environment is revived or hibernated accordingly.

In another implementation, multi-tasking systems rely on each process in the system to regularly give up time to other processes in the system. The maximized application is the sole foreground application and consumes CPU processing time with the highest priority and consumes primary memory far more than the other minimized applications. Raised icons represent applications being executed, but minimized applications, which are processing in the background with some portion of memory, which could be swapped in and out from primary memory to secondary storage. Minimized applications consume far less CPU processing time than maximized applications. Both maximized and minimized applications are executed only when their environments are revived. With existing technologies, developers can easily design keyboard shortcuts to toggle between various executed applications, or use down-arrow and up-arrow buttons to switch between minimized applications and maximized applications.

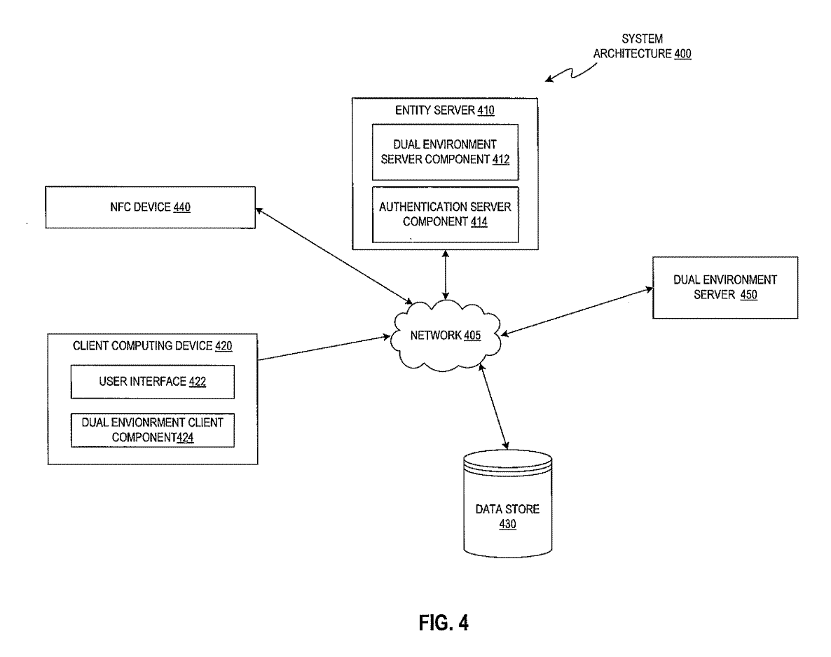

FIG. 4 illustrates an example system architecture 400 for implementing dual environments with 3-D Earth-like GUI, in accordance with an implementation of the disclosure. The system architecture 400 includes an entity server 410, a client computing devices 420, a data store 430, an NFC device 440, and a dual environment server 450. The components 410-450 may be communicatively coupled/connected via a network 405. In one implementation, the network 405 may include a public network (e.g., the Internet), a private network (e.g., a local area network (LAN) or wide area network (WAN)), a wired network (e.g., Ethernet network), a wireless network (e.g., an 802.11 network, Bluetooth, NFC, or a Wi-Fi network), a cellular network (e.g., a Long Term Evolution (LTE) network), routers, hubs, switches, server computers, and/or a combination thereof. In some implementations, the network 405 may be a combination of different types of networks.

In one implementation, the entity server 410 and the dual environment server 450 may each correspond to one or more computing devices (e.g., a rackmount server, a router computer, a server computer, a personal computer, a mainframe computer, a laptop computer, a tablet computer, a desktop computer, etc.), data stores (e.g., hard disks, memories, databases), networks, software components, and/or hardware components. The entity server 410 may utilize data received from the dual environment server 450 to manage, monitor, and communicate with client computing device 420 in order to implement a dual environment with 3-D Earth-like GUI, where the dual environment includes submissive applications. Specifically, the entity server 410 may include a dual environment server component 412 (which may be executed by a processing device of the entity server 410) that is capable of initializing, managing, and enforcing dual environments with 3-D Earth-like GUIs on client computing device 420, as described further below. In some implementations, the dual environment server component 412 may be implemented on a different device than entity server 410.

In one implementation, the data store 430 may be a memory (e.g., random access memory), a cache, a drive (e.g., a hard drive), a flash drive, a database system, or another type of component or device capable of storing data. The data store 430 may also include multiple storage components (e.g., multiple drives or multiple databases) that may also span multiple computing devices (e.g., multiple server computers), and may be cloud-based. In some implementations, the data store 430 may be a part of the entity server 410. In some implementations, the data store 430 may be distributed among and accessible to the entity server 410, the client computing device 420, the NFC device 440, and/or the dual environment server 450. One or more of the devices of the system architecture 400 may utilize the data store 430 to store public and private data. The data store 430 may be configured to provide secure storage for private data.

In one implementation, the client computing device 420 may include computing devices such as personal computers (PCs), laptops, mobile phones, smart phones, tablet computers, netbook computers, etc. The client computing device 420 may also be referred to as “user device” or “end user device”. Although a single client computing device 420 is illustrated in FIG. 4, more than one client computing device 420 may be part of system architecture 400. An individual user may be associated with (e.g., own and/or use) the client computing device 420. As used herein, a “user” may refer generally to an individual operator of the client computing device 420.

In one implementation, the client computing device 420 may implement a user interface 422. The user interface 422, which may also be referred to as a graphical user interface (GUI), may allow a user of the respective client computing device 420 to send/receive information to/from the entity server 410, the NFC device 440, the data store 430, and the dual environment server 450. For example, the user interface 422 may be a web browser interface that can access, retrieve, present, and/or navigate content (e.g., web pages such as Hyper Text Markup Language (HTML) pages) provided by the entity server 410. In one implementation, the user interface 422 may be a standalone dual environment application (e.g., a mobile app), which may have been provided by the entity server 410 (e.g., as a downloadable application to be installed by an administrator) or by the dual environment server 450. The user interface 422 may allow for the client computing device 420 to send/receive information to/from the entity server 410 and/or the dual environment server 450.

In one implementation, a dual environment client component 424 executes on the client computing device 420. The dual environment client component 424 may be provided to client computing device by dual environment server 450. For example, the dual environment client component 424 may cause the user interface 422 to implement a dual environment with 3-D Earthlike GUI according to the description above. Specifically, the dual environment may include a northern and southern hemisphere each associated with a business use and a home/personal use, respectively. In the dual environment, one or more applications that are always executing (e.g., the dual environment NFC SmartTag application and other key applications such as emergency services) are located at the “equator” or the mid-line between the dual environments.

The dual environment client component 424 may include, at least in part, an NFC SmartTag application that interacts with an NFC device 440 when the client computing device 420 is placed in close proximity to the NFC device 440. This NFC SmartTag application operates as a built-in NFC communication device for the client computing device 420, enabling interactions via NFC with another NFC device, such as NFC device 440. In some implementations, the user interface 422 may allow the respective client computing device 420 to interact directly with the entity server 410 without interacting with the NFC device 440.

In one implementation, the NFC SmartTag application and/or the NFC device 440 is a device that is capable of communicating with other devices using NFC protocols or standards. NFC protocols or standards allow for two devices to establish radio communication with each other by placing the devices in physical proximity with each other. The physical proximity may range up to a few centimeters (e.g., up to 10 cm), a few inches (e.g., up to 12 inches), or a few feet (e.g., up to 5 feet). NFC protocols and/or standards may include, for example, the Android™ Beam standard which allows data exchange between two computing devices (e.g., two devices that use the Android™ operating system). When an initiating device (e.g., the client computing device 420 having an NFC application as part of dual environment client component 424) comes in close enough proximity to a receiving device (e.g., NFC device 440), the initiating device may present for display a user interface that facilitations data exchange between the devices.

In some implementations, the NFC device 424, 440 may be built into a computing device. For example, NFC protocol provided by dual environment client component 424 may be built into client computing device 420 (which may be computing device such as a personal computer (PC), a laptop computer, a mobile phone, a smart phone, a cellular phone, a personal digital assistant (PDA), a tablet computer, a netbook computer, etc.). In other implementations, the NFC protocol provided by dual environment client component 424 may be separate from a computing device. For example, the NFC component of dual environment client component 424 may be provided on a smartwatch device (e.g., a computing device that is wearable on a wrist or arm of the user and is capable of communication via NFC protocols or standards). The smartwatch may be coupled to another computing device (e.g., a smartphone) via a wired or wireless connection (e.g., via Bluetooth, via 802.11 protocols, etc.). It is to be understood that the phrase “an NFC device of a client computing device”, as used herein, may refer to a client computing device having a built in NFC device or a client computing device communicatively coupled to a separate NFC device (e.g., by a wired or wireless connection).

In one implementation, the NFC device 440 may be provided or installed (e.g., as a sticker that is attached to a surface, as computing device, etc.) at fixed geographical locations (e.g., in an office building entrance, in a restaurant, a mall entrance, a movie theater, etc.). NFC device 440 may also be installed on table tops (e.g., on the surface of a table at a restaurant, bar, etc.), on posters/billboards (e.g., included on a “smart poster”), or included as part of a display, stand, or other physical structure. In some implementations, the NFC device 440 may include power sources (e.g., a battery or power supply coupled to a power outlet), which allow the NFC devices 440 to communicate without utilizing the RF field and/or magnetic field generated by other devices (e.g., NFC protocol provided by dual environment client component 424). In some implementations, the NFC device 440 may be included in any location or on any surface.

In some implementations, the NFC device 440 is a passive device (e.g., not connected to a power source), and may be powered by a generated RF field and/or a magnetic field of an initiating NFC device (e.g., dual environment client component 424) that comes within physical proximity. Such passive devices may be provided in various forms, such as tags, stickers, key fobs, labels, etc., and may contain read-only data, rewriteable data, and combinations thereof. For example, a manufacturer or distributor of the passive NFC device 440 may be able to write and/or modify the data of the devices using various hardware and/or software components.

In some implementations, the NFC device 440 may include storage (e.g., memory, cache, etc.) that is used to store the data locally. For example, the NFC device 440 may locally store identifiers of specific client computing devices 420. In some implementations, the NFC device 440 may transmit data stored in its storage to the entity server 410, and may also update the data stored in its storage based on data received from the entity server 410 and/or the dual environment server 450.

The client computing device 420 may be associated with an identifier that identifies the client computing device 420 to the dual environment server component 412 at the entity server 410 (e.g., via communication with NFC device 440). In some implementations, when NFC component of dual environment client component 424 comes into proximity with the NFC device 440, the client computing device 420 provides its identifier to the NFC device 440. The NFC device 440 communicates the identifier to the entity server 410, and the dual environment server component 412 may then work in conjunction with an authentication server component 414 of the entity server 410 to authenticate the client computer device 420.

In one implementation, after the client computing device is successfully authenticated by authentication server component 414, the NFC devices 440 may include/encode instructions and/or data that, when one of the client computing device 420 is in physical proximity, submissively trigger the client computing device 420 to hibernate one of the dual environments implemented by dual environment client component 424 on client computing device 420. For example, the client computing device 420 is submissively triggered by NFC radio frequencies at the NFC device 440 to hibernate the home environment (e.g., the southern hemisphere) and revive the business environment (e.g., the northern hemisphere) on the user interface 422 of client computing device 420. In one implementation, when an environment (e.g., northern or southern hemisphere) is in a hibernated mode, all applications in that hemisphere are inactive. When an application is “inactive” in the hibernated mode, that may refer to disabling the application so that the end user cannot interact with the application (e.g., inoperable). In some implementations, a user may be able to manually override the hibernated state of an application. In some cases, the dual environment client component 424 may log activity associated with manual overrides of a hibernated state, and cause this log data to be transmitted to entity server 410 upon the next interaction with NFC device 440.

In further implementations, the hibernation and revival of each of the dual environments may be based on factors other than proximity to the NFC device 440. For example, submissive hibernation and revival of an environment of a computing device may be based on, but is not limited to, a time, location, network (e.g., mobile telecommunication network, local area network, and wide area network), wireless communication network (e.g., Wi-Fi, radio frequencies), programmed schedule, and/or biometric security, to name a few examples. Implementations of the disclosure are not meant to be limited to submissive hibernation and/or revival solely based on NFC proximity. Instead, NFC proximity is provided as just one of many examples to cause submissive hibernation and revival of the dual environments presented in the 3-D Earth-like GUI described herein.

In one implementation, the entity server 410 and/or other servers may monitor the NFC device 440 that the client computing device 420 communicates and/or comes into physical proximity with. For example, for a user of client computing device 420, a server may monitor the times, locations, dates, duration, etc., that the client computing device 420 comes into proximity with the NFC device 440. The client computing device 420 may store this information and then transmit this information to a server (e.g., the entity server 410). The server may use this information to compute statistical information (e.g., the number of times a user has interacted with a particular NFC device 440) and to learn the behavior of the user (e.g., when the user tends to visit certain NFC devices 440).

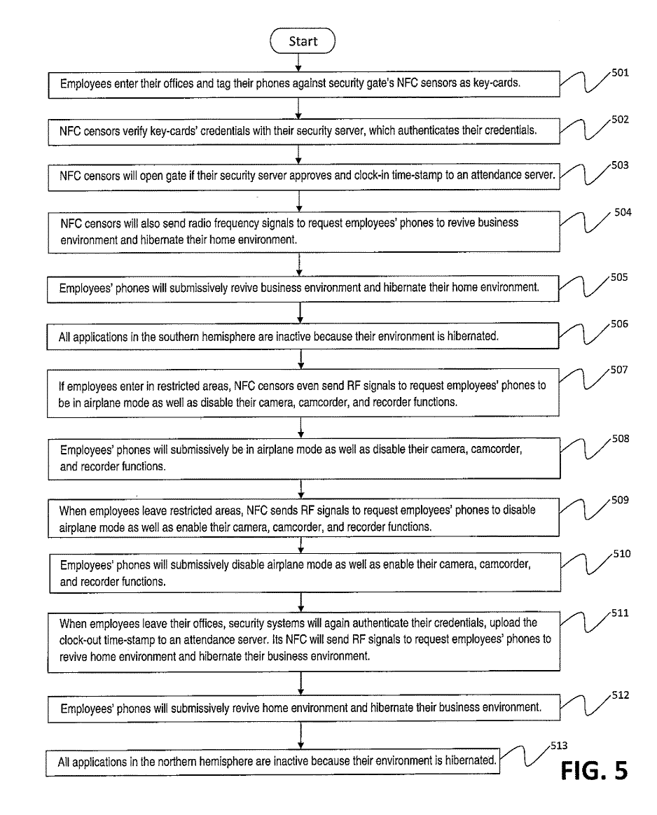

FIG. 5 is a flow chart illustrating 3-D Earth-like graphical user interface systems and methods to show smart phones are submissively revived or hibernated between home and business environments triggered by NFC's RF signals. The method 500 may be performed by processing logic that comprises hardware (e.g., circuitry, dedicated logic, programmable logic, microcode, etc.), software (e.g., instructions run on a processing device to perform hardware simulation), or a combination thereof.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 500 may be performed by various components of system architecture 400 as shown in FIG. 4.

Referring to FIG. 5, method 500 begins at block 501 when employees enter their offices and tag their phones against security gate's NFC sensors as key-cards.

At block 502, NFC censors verify key-cards' credentials with their security server, which authenticates their credentials.

At block 503, NFC censors open a gate if their security server approves and clock-in time-stamp to an attendance server.

At block 504, NFC censors also send radio frequency signals to request employees' phones to revive business environment and hibernate their home environment.

At block 505, employees' phones submissively revive business environment and hibernate their home environment.

At block 506, all applications in the southern hemisphere are inactive because their environment is hibernated.

At block 507, if employees enter in restricted areas, NFC censors even send RF signals to request employees' phones to be in airplane mode as well as disable their camera, camcorder, and recorder functions.

At block 508, employees' phones are placed submissively in airplane mode as well as disable their camera, camcorder, and recorder functions.

At block 509, when employees leave restricted areas, NFC sends RF signals to request employees' phones to disable airplane mode as well as enable their camera, camcorder, and recorder functions.

At block 510, employees' phones submissively disable airplane mode as well as enable their camera, camcorder, and recorder functions.

At block 511, when employees leave their offices, security systems again authenticate their credentials, upload the clock-out time-stamp to an attendance server. Its NFC sends RF signals to request employees' phones to revive home environment and hibernate their business environment.

At block 512, employees' phones submissively revives home environment and hibernates their business environment.

At block 513, all applications in the northern hemisphere are inactive because their environment is hibernated.

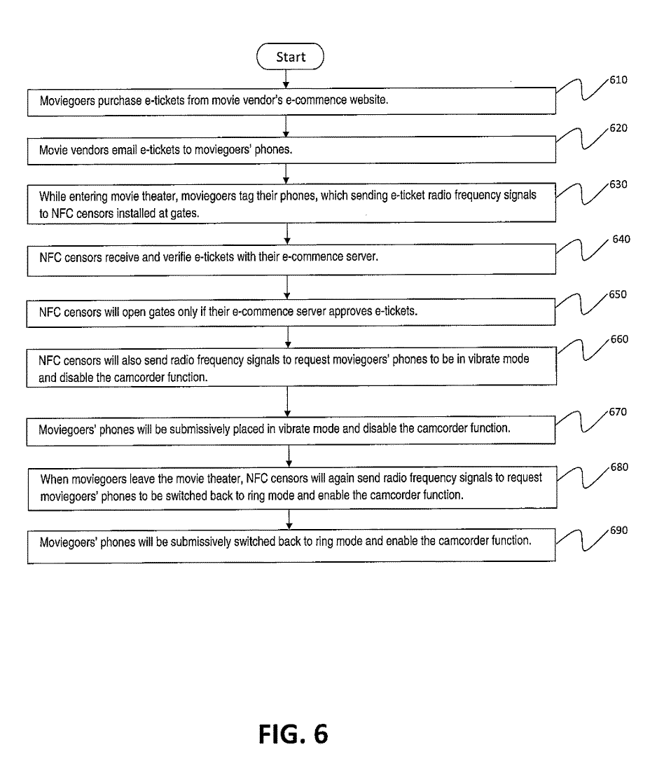

FIG. 6 is a flow chart illustrating 3-D Earth-like graphical user interface systems and methods to show smart phones are submissively in vibrate or ring mode triggered by NFC's RF signals. The method 600 may be performed by processing logic that comprises hardware (e.g., circuitry, dedicated logic, programmable logic, microcode, etc.), software (e.g., instructions run on a processing device to perform hardware simulation), or a combination thereof. In one implementation, method 600 may be performed by various components of system architecture 400, as shown in FIG. 4.

Referring to FIG. 6, method 600 begins at block 610 when moviegoers purchase e-tickets from movie vendor's e-commence website.

At block 620, movie vendors email e-tickets to moviegoers' phones.

At block 630, while entering movie theater, moviegoers tag their phones, which sending e-ticket radio frequency signals to NFC censors installed at gates.

At block 640, NFC censors receive and verify e-tickets with their e-commence server.

At block 650, NFC censors opens the gates only if their e-commence server approves e-tickets.

At block 660, NFC censors also send radio frequency signals to request moviegoers' phones to be in vibrate mode and disable the camcorder function.

At block 670, moviegoers' phones are submissively placed in vibrate mode and disable the camcorder function.

At block 680, when moviegoers leave the movie theater, NFC censors again send radio frequency signals to request moviegoers' phones to be switched back to ring mode and enable the camcorder function.

At block 690, moviegoers' phones are submissively switched back to ring mode and enable the camcorder function.

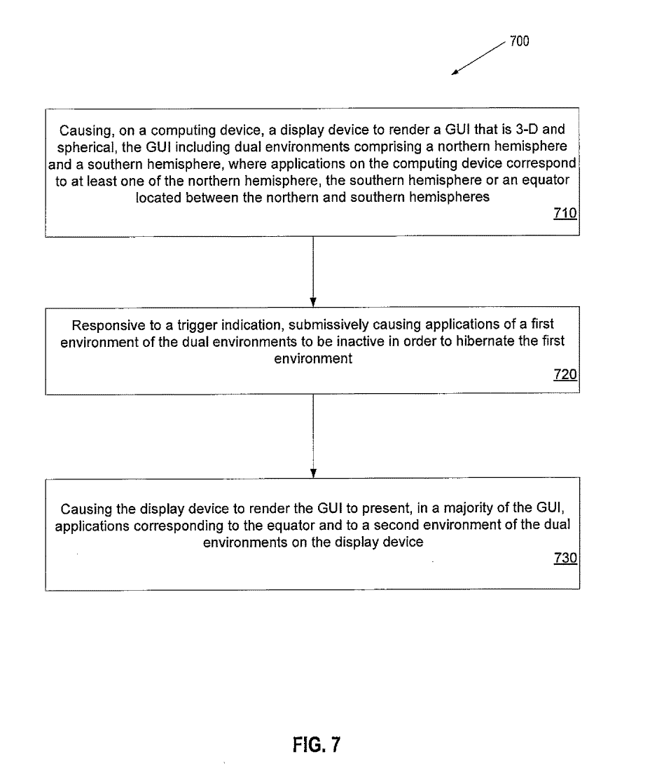

FIG. 7 is a flow diagram illustrating a method 700 for providing dual environment with 3-D Earth-like GUI according to an implementation of the disclosure. The method 700 may be performed by processing logic that comprises hardware (e.g., circuitry, dedicated logic, programmable logic, microcode, etc.), software (e.g., instructions run on a processing device to perform hardware simulation), or a combination thereof. In one implementation, method 700 may be performed by client computing device 420, as shown in FIG. 4.

Referring to FIG. 7, method 700 begins at block 710 when a processing device causes a display device to render a GUI that is presented in a 3-D and spherical format. The GUI includes dual environments that include a northern hemisphere and a southern hemisphere. Applications on the computing device may correspond to one of the northern hemisphere, the southern hemisphere, or an equator that is between the northern and southern hemispheres. At block 720, the processing device submissively causes, responsive to a trigger indication, applications of a first environment of the dual environments to be inactive in order to hibernate the first environment on the computing device. Lastly, at block 730, the processing device causes the display device to render the GUI to present, in a majority of the GUI, applications corresponding to the equator and a second environment of the dual environments on the display device. At the same time, the applications of the hibernated first environment are shown in a minority of the display device, such as in a lower portion of the GUI or in an edge area of the GUI.

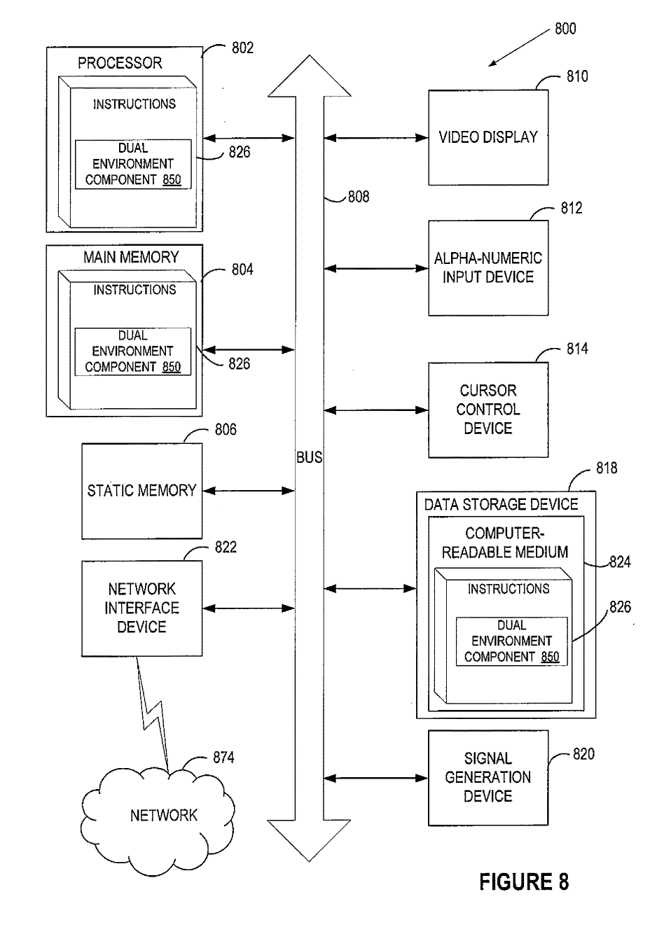

FIG. 8 illustrates a diagrammatic representation of a machine in the exemplary form of a computer system 800 within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 800 includes a processing device (processor) 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage device 818, which communicate with each other via a bus 808.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 may also be one or more special-purpose processing devices such as an application specific integrated circuit (ASIC), a field programmable gate array (FPGA), a digital signal processor (DSP), network processor, or the like. The processor 802 is configured to execute instructions 826 for performing the operations and steps discussed herein.

The computer system 800 may further include a network interface device 822. The computer system 800 also may include a video display unit 810 (e.g., a liquid crystal display (LCD), a cathode ray tube (CRT), or a touch screen), an alphanumeric input device 812 (e.g., a keyboard), a cursor control device 814 (e.g., a mouse), and a signal generation device 820 (e.g., a speaker).

The data storage device 818 may include a computer-readable storage medium 824 on which is stored one or more sets of instructions 826 (e.g., software) embodying any one or more of the methodologies or functions described herein. The instructions 826 may also reside, completely or at least partially, within the main memory 804 and/or within the processor 802 during execution thereof by the computer system 800, the main memory 804 and the processor 802 also constituting computer-readable storage media. The instructions 826 may further be transmitted or received over a network 874 via the network interface device 822.

In one implementation, the instructions 826 include instructions for a dual environment component 850, which may correspond, respectively, to dual environment client component 424 and/or server-side dual environment server component 412 described with respect to FIG. 4, and/or a software library containing methods that provide dual environments with 3-D Earth-like GUI. While the computer-readable storage medium 824 is shown in an exemplary implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “segmenting”, “analyzing”, “determining”, “enabling”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

The above description is intended to be illustrative and not restrictive. For example, the above-described examples (or one or more aspects thereof) may be used in combination with each other. Other implementations can be used, such as by one of ordinary skill in the art upon reviewing the above description. The abstract is provided to comply with 37 CFR 1.72(b) to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description, with each claim standing on its own as a separate implementation, and it is contemplated that such implementations can be combined with each other in various combinations or permutations. The scope of the implementations of the disclosure should be determined with reference to the appended claims, along with the full scope of equivalents to which such claims are entitled.

In the drawings, which are not necessarily drawn to scale, like numerals may describe similar components in different views. Like numerals having different letter suffixes may represent different instances of similar components. The drawings illustrate generally, by way of example, but not by way of limitation, various implementations discussed in the present document.

What is claimed is:

1. A method, comprising:
causing, by a processing device of a computing device, a display device of the computing device to render a graphical user interface (GUI) that is three-dimensional and spherical, the GUI comprising dual environments comprising a northern hemisphere and a southern hemisphere, wherein applications executed by the processing device on the computing device correspond to at least one of the northern hemisphere, the southern hemisphere, or an equator between the northern and southern hemispheres;
responsive to a trigger indication, submissively causing, by the processing device, applications of a first environment of the dual environments to be inactive in order to hibernate the first environment on the computing device; and
causing, by the processing device, the display device to render the GUI to present, in a majority of the GUI, applications corresponding to the equator and to a second environment of the dual environments on the display device.

2. The method of claim 1, wherein the GUI is rendered as an Earth-like presentation on the display with the applications corresponding to the northern hemisphere located above applications corresponding to the equator and applications corresponding to the southern hemisphere located below applications corresponding to the equator.

3. The method of claim 1, wherein the trigger indication comprises at least one of a time, a location, a network, a wireless communication network, a programmed schedule, or a biometric security.

4. The method of claim 3, wherein the network comprises at least one of a mobile telecommunication network, a local area network, or a wide area network, and wherein the wireless communication comprises at least one of a Wi-Fi network, Bluetooth, near-field communication (NFC) network, or a radio frequency.

5. The method of claim 3, further comprising responsive to manual revival of the first environment to execute one of the applications of the first environment, automatically reporting, by the processing device, to a server device corresponding to the trigger indication.

6. The method of claim 1, wherein applications corresponding to the equator do not correspond to either of the dual environments and remain active during operation of the computing device.

7. The method of claim 1, wherein applications corresponding to the first environment are not executable until the first environment is revived.

8. The method of claim 1, wherein the northern hemisphere corresponds to business use applications and the southern hemisphere corresponds to at least one of home or personal use applications.

9. The method of claim 1, wherein the applications are represented by icons in the GUI.

10. The method of claim 9, wherein icons can be framed in different colors that represent a different status comprising at least one of active, inactive, or alert.

11. The method of claim 9, wherein the applications that are executed, minimized, and running in the background are depicted as raised icons in the GUI.

12. A system, comprising:
a memory;
a display device communicably coupled to the memory; and
a processing device communicably coupled to the memory and the display device, the processing device to:
cause the display device to render a graphical user interface (GUI) that is three-dimensional and spherical, the GUI comprising dual environments comprising a northern hemisphere and a southern hemisphere, wherein applications executed by the processing device on the computing device correspond to at least one of the northern hemisphere, the southern hemisphere, or an equator between the northern and southern hemispheres;
responsive to a trigger indication, submissively cause applications of a first environment of the dual environments to be inactive in order to hibernate the first environment on the computing device; and
cause the display device to render the GUI to present, in a majority of the GUI, applications corresponding to the equator and to a second environment of the dual environments on the display device.

13. The system of claim 12, wherein the GUI is rendered as an Earth-like presentation on the display with the applications corresponding to the northern hemisphere located above applications corresponding to the equator and applications corresponding to the southern hemisphere located below applications corresponding to the equator.

14. The system of claim 12, wherein the trigger indication comprises at least one of a time, a location, a network, a wireless communication network, a programmed schedule, or a biometric security.

15. The system of claim 14, wherein the network comprises at least one of a mobile telecommunication network, a local area network, or a wide area network, and wherein the wireless communication comprises at least one of a Wi-Fi network, Bluetooth, near-field communication (NFC) network, or a radio frequency.

16. The system of claim 14, wherein the processing device is further to, responsive to manual revival of the first environment to execute one of the applications of the first environment, automatically report to a server device corresponding to the trigger indication.

17. The system of claim 12, wherein applications corresponding to the equator do not correspond to either of the dual environments and remain active during operation of the computing device.

18. The system of claim 12, wherein applications corresponding to the first environment are not executable until the first environment is revived.

19. The system of claim 12, wherein the northern hemisphere corresponds to business use applications and the southern hemisphere corresponds to at least one of home or personal use applications.

20. The system of claim 12, wherein the applications are represented by icons in the GUI.

21. The system of claim 20, wherein icons can be framed in different colors that represent a different status comprising at least one of active, inactive, or alert.

22. The system of claim 20, wherein the applications that are executed, minimized, and running in the background are depicted as raised icons in the GUI.

23. A non-transitory machine-readable storage medium storing instructions which, when executed, cause a processing device of a computing device to perform operations comprising:
causing a display device of the computing device to render a graphical user interface (GUI) that is three-dimensional and spherical, the GUI comprising dual environments comprising a northern hemisphere and a southern hemisphere, wherein applications executed by the processing device on the computing device correspond to at least one of the northern hemisphere, the southern hemisphere, or an equator between the northern and southern hemispheres;
responsive to a trigger indication, submissively causing applications of a first environment of the dual environments to be inactive in order to hibernate the first environment on the computing device; and
causing the display device to render the GUI to present, in a majority of the GUI, applications corresponding to the equator and to a second environment of the dual environments on the display device.

24. The non-transitory machine-readable storage medium of claim 23, wherein the GUI is rendered as an Earth-like presentation on the display with the applications corresponding to the northern hemisphere located above applications corresponding to the equator and applications corresponding to the southern hemisphere located below applications corresponding to the equator.

25. The non-transitory machine-readable storage medium of claim 23, wherein the trigger indication comprises at least one of a time, a location, a network, a wireless communication network, a programmed schedule, or a biometric security.

26. The non-transitory machine-readable storage medium of claim 25, wherein the network comprises at least one of a mobile telecommunication network, a local area network, or a wide area network, and wherein the wireless communication comprises at least one of a Wi-Fi network, Bluetooth, near-field communication (NFC) network, or a radio frequency.

27. The non-transitory machine-readable storage medium of claim 25, wherein the processing device is further to, responsive to manual revival of the first environment to execute one of the applications of the first environment, automatically report to a server device corresponding to the trigger indication.

28. The non-transitory machine-readable storage medium of claim 23, wherein applications corresponding to the equator do not correspond to either of the dual environments and remain active during operation of the computing device.

29. The non-transitory machine-readable storage medium of claim 23, wherein applications corresponding to the first environment are not executable until the first environment is revived.

30. The non-transitory machine-readable storage medium of claim 23, wherein the northern hemisphere corresponds to business use applications and the southern hemisphere corresponds to at least one of home or personal use applications.

31. The non-transitory machine-readable storage medium of claim 23, wherein the applications are represented by icons in the GUI.

32. The non-transitory machine-readable storage medium of claim 31, wherein icons can be framed in different colors that represent a different status comprising at least one of active, inactive, or alert.

33. The non-transitory machine-readable storage medium of claim 31, wherein the applications that are executed, minimized, and running in the background are depicted as raised icons in the GUI.
